(19) United States
(12) Patent Application Publication
(10) Pub. No.: US 2025/0184798 A1
(43) Pub. Date: Jun. 5, 2025

(54) METHOD AND APPARATUS FOR MEASUREMENT REPORTING IN COMMUNICATION SYSTEM

(71) Applicant: Electronics and Telecommunications Research Institute, Daejeon (KR)

(72) Inventors: Hyun Seo PARK, Daejeon (KR); Yong Jin KWON, Daejeon (KR); Yunjoo KIM, Daejeon (KR); Seungjae BAHNG, Daejeon (KR); Jungbo SON, Daejeon (KR); Anseok LEE, Daejeon (KR); Yu Ro LEE, Daejeon (KR); Sung Cheol CHANG, Daejeon (KR); Heesoo LEE, Daejeon (KR)

(21) Appl. No.: 18/967,456

(22) Filed: Dec. 3, 2024

(30) Foreign Application Priority Data
Dec. 4, 2023 (KR) 10-2023-0173613
Dec. 3, 2024 (KR) 10-2024-0177510

(51) Int. Cl. H04W 24/10; H04L 5/00

(52) U.S. Cl. CPC H04W 24/10; H04L 5/0048

(57) ABSTRACT

A method of a terminal may comprise: receiving, from a base station, configuration information on first reference signal resources; obtaining a measurement result by performing measurement on the first reference signal resources according to the configuration information; performing layer 1 (L1) filtering on the measurement result; and in response to the L1-filtered measurement result satisfying a measurement reporting condition, reporting the L1-filtered measurement result to the base station.

### CROSS-REFERENCE TO RELATED APPLICATIONS

This application claims priority to Korean Patent Applications No. 10-2023-0173613, filed on Dec. 4, 2023, and No. 10-2024-0177510, filed on Dec. 3, 2024, with the Korean Intellectual Property Office (KIPO), the entire contents of which are hereby incorporated by reference.

### BACKGROUND

### 1. Technical Field

The present disclosure relates to a measurement reporting technique in a communication system, and more particularly, to a measurement reporting technique for a terminal to report a measurement result or measurement prediction result to a base station upon identifying occurrence of a specific event for the measurement result or measurement prediction result of the terminal.

### 2. Related Art

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g. Long Term Evolution (LTE) communication system or LTE-Advanced (LTE-A) communication system), the 5th generation (5G) communication system (e.g. new radio (NR) communication system) that uses a frequency band (e.g. a frequency band of 6 GHz or above) higher than that of the 4G communication system as well as a frequency band of the 4G communication system (e.g. a frequency band of 6 GHz or below) is being considered. The 5G communication system may support enhanced Mobile BroadBand (eMBB), Ultra-Reliable and Low-Latency Communication (URLLC), and massive Machine Type Communication (mMTC).

Meanwhile, a base station may configure a terminal in a connected state to report a measurement result. The base station may configure synchronization signal block (SSB) or channel state information (CSI) resources for the terminal to measure, and configure the terminal to report the measurement result. In this case, the terminal may frequently report the measurement result to the base station. Accordingly, the base station may frequently receive the measurement result from the terminal, and signaling overhead may increase due to the terminal's frequent reporting. On the other hand, the terminal may occasionally report the measurement result to the base station, and signaling overhead may be reduced. However, if the base station receives the measurement result from the terminal only occasionally, accurate operation may become difficult.

### SUMMARY

The present disclosure for resolving the above-described problems is directed to providing a method and an apparatus for measurement reporting in a communication system, which allow a terminal to report a measurement result or measurement prediction result when an occurrence of a specific event for the measurement result or measurement prediction result of the terminal is identified.

According to a first exemplary embodiment of the present disclosure, a method of a terminal may comprise: receiving, from a base station, configuration information on first reference signal resources; obtaining a measurement result by performing measurement on the first reference signal resources according to the configuration information; performing layer 1 (L1) filtering on the measurement result; and in response to the L1-filtered measurement result satisfying a measurement reporting condition, reporting the L1-filtered measurement result to the base station.

The performing of the L1 filtering on the measurement result may comprise: identifying a filtering window; in response to the filtering window being a new filtering window, performing initialization of the L1 filtering; and performing the L1 filtering based on the filtering window.

The performing of the L1 filtering based on the filtering window may comprise: identifying L1 measurement samples within the filtering window; and performing the L1 filtering based on the L1 measurement samples.

The performing of the L1 filtering based on the L1 measurement samples may comprise: applying weights to the L1 measurement samples; and performing the L1 filtering based on the L1 measurement samples to which the weights are applied.

The performing of the L1 filtering based on the filtering window may comprise: identifying an L1-filtered measurement result of a previous filtering window of the filtering window; identifying L1 measurement samples within the filtering window; and performing the L1 filtering based on the L1 measurement samples within the filtering window and the L1-filtered measurement result of the previous filtering window.

The method may further comprise: receiving, from the base station, prediction configuration information on second reference signal resources; obtaining a measurement prediction result by performing measurement prediction on the second reference signal resources according to the prediction configuration information; performing L1 filtering on the measurement prediction result; and in response to the L1-fitered measurement prediction result satisfying a measurement prediction reporting condition, reporting the L1-filtered measurement prediction result to the base station.

The prediction configuration information may further include a measurement prediction condition, and the performing of the measurement prediction on the second reference signal resources may comprise: in response to the measurement prediction condition being satisfied, performing measurement prediction on the second reference signal resources according to the prediction configuration information.

The measurement prediction condition may be satisfied when a value obtained by adding a first offset to an L1-filterd L1 measurement result of a reference signal resource of a candidate cell is greater than or equal to an L1-filtered L1 measurement result of a reference signal resource of a serving cell.

The measurement prediction condition may be satisfied when an L1-filtered L1 measurement result of a reference signal resource of a serving cell is less than a threshold.

The method may further comprise: receiving, from the base station, a feedback request for a prediction result accuracy; calculating the prediction result accuracy according to the feedback request; and transmitting the calculated prediction result accuracy to the base station.

The prediction result accuracy may include at least one of accuracy, precision, recall rate, false positive ratio, false negative ratio, or false ratio for the measurement prediction result.

The measurement reporting condition may be satisfied when an L1-filtered L1 measurement result of a reference signal resource of a candidate cell is equal to or greater than an L1-filtered L1 measurement result of a reference signal resource of a serving cell, by a second offset.

According to a second exemplary embodiment of the present disclosure, a method of a base station may comprise: transmitting, to a terminal, configuration information on first reference signal resources and a measurement reporting condition; and receiving, from the terminal, a layer 1 (L1)-filtered measurement result for the first reference signal resources according to the configuration information, wherein the L1-filtered measurement result satisfies the measurement reporting condition.

The measurement reporting condition may be satisfied when an L1-filtered L1 measurement result of a reference signal resource of a candidate cell is equal to or greater than an L1-filtered L1 measurement result of a reference signal resource of a serving cell, by a second offset.

The method may further comprise: transmitting, to the terminal, prediction configuration information for second reference signal resources and a prediction reporting condition; and receiving, from the terminal, an L1-filtered measurement prediction result for the second reference signal resources according to the prediction configuration information.

The method may further comprise: requesting, from the terminal, a feedback for a prediction result accuracy; and receiving, from the terminal, the prediction result accuracy according to the feedback request.

According to a third exemplary embodiment of the present disclosure, a terminal may comprise at least one processor, wherein the at least one processor may cause the terminal to perform: receiving, from a base station, configuration information on first reference signal resources; obtaining a measurement result by performing measurement on the first reference signal resources according to the configuration information; performing layer 1 (L1) filtering on the measurement result; and in response to the L1-filtered measurement result satisfying a measurement reporting condition, reporting the L1-filtered measurement result to the base station.

In the performing of the L1 filtering on the measurement result, the at least one processor may cause the terminal to perform: identifying a filtering window; in response to the filtering window being a new filtering window, performing initialization of the L1 filtering; and performing the L1 filtering based on the filtering window.

The at least one processor may further cause the terminal to perform: receiving, from the base station, prediction configuration information on second reference signal resources; obtaining a measurement prediction result by performing measurement prediction on the second reference signal resources according to the prediction configuration information; performing L1 filtering on the measurement prediction result; and in response to the L1-fitered measurement prediction result satisfying a measurement prediction reporting condition, reporting the L1-filtered measurement prediction result to the base station.

The at least one processor may further cause the terminal to perform: receiving, from the base station, a feedback request for a prediction result accuracy; calculating the prediction result accuracy according to the feedback request; and transmitting the calculated prediction result accuracy to the base station.

According to the present disclosure, a terminal can report a measurement result or measurement prediction result to a base station upon identifying occurrence of a specific event according to the measurement result obtained by measuring signals received from the base station or the predicted measurement result. The base station can receive the measurement result or measurement prediction result from the terminal, and improve performance by accurately performing mobility management based on the received measurement result or measurement prediction result.

### BRIEF DESCRIPTION OF DRAWINGS

FIG. 1 is a conceptual diagram illustrating a first exemplary embodiment of a communication system.

FIG. 2 is a block diagram illustrating a first exemplary embodiment of a communication node constituting a communication system.

FIG. 3 is a sequence chart illustrating exemplary embodiments of an L1/L2-based mobility management method.

FIG. 4 is a flow chart illustrating exemplary embodiments of a measurement result reporting method in a communication system.

FIG. 5 is a flow chart illustrating exemplary embodiments of the measurement method and filtering method of FIG. 4.

FIG. 6 is a flow chart illustrating exemplary embodiments of a measurement reporting method in a communication system.

FIG. 7 is a flow chart illustrating exemplary embodiments of the method for ranking measurement results and applying filtering in FIG. 6.

FIG. 8 is a flow chart illustrating exemplary embodiments of a measurement prediction reporting method in a communication system.

FIG. 9 is a flow chart illustrating exemplary embodiments of the measurement prediction method and filtering method in FIG. 8.

FIG. 10 is a flow chart illustrating exemplary embodiments of a measurement prediction reporting method in a communication system.

FIG. 11 is a flow chart illustrating exemplary embodiments of the method for ranking measurement prediction results and applying filtering in FIG. 10.

FIG. 12 is a block diagram illustrating exemplary embodiments of a terminal supporting measurement reporting methods in a mobile communication system.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one A or B” or “at least one of one or more combinations of A and B”. In addition, “one or more of A and B” may refer to “one or more of A or B” or “one or more of one or more combinations of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, forms of the present disclosure will be described in detail with reference to the accompanying drawings. In describing the disclosure, to facilitate the entire understanding of the disclosure, like numbers refer to like elements throughout the description of the figures and the repetitive description thereof will be omitted.

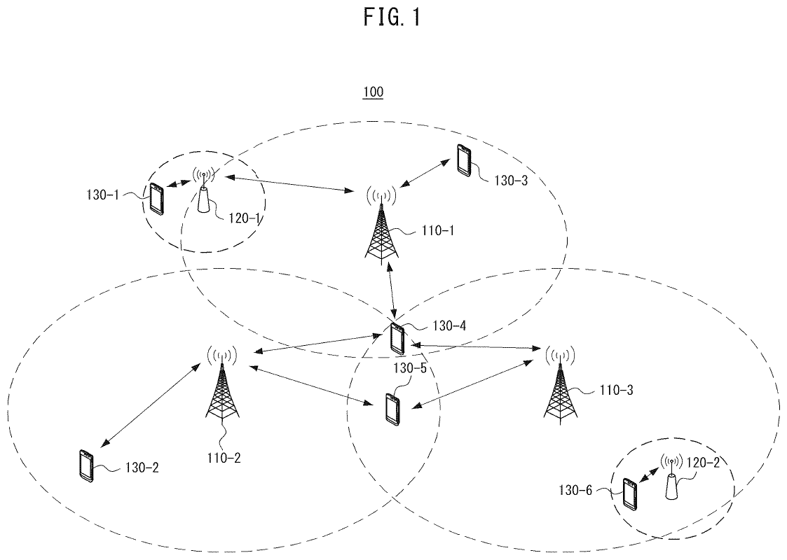

FIG. 1 is a conceptual diagram illustrating a first exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. Here, the communication system may be referred to as a ‘communication network’. Each of the plurality of communication nodes may support code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, orthogonal frequency division multiple access (OFDMA) based communication protocol, single-carrier FDMA (SC-FDMA) based communication protocol, non-orthogonal multiple access (NOMA) based communication protocol, space division multiple access (SDMA) based communication protocol, or the like. Each of the plurality of communication nodes may have the following structure.

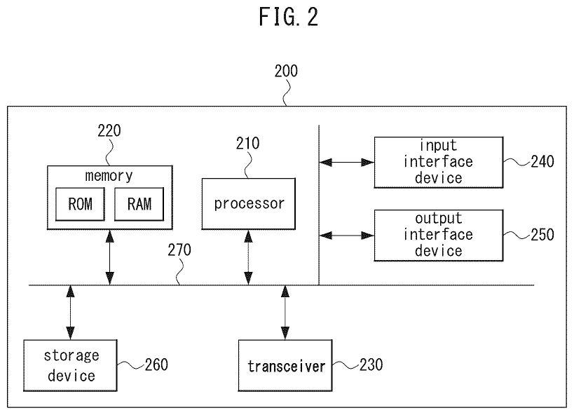

FIG. 2 is a block diagram illustrating a first exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. The respective components included in the communication node 200 may communicate with each other as connected through a bus 270. However, the respective components included in the communication node 200 may be connected not to the common bus 270 but to the processor 210 through an individual interface or an individual bus. For example, the processor 210 may be connected to at least one of the memory 220, the transceiver 230, the input interface device 240, the output interface device 250, and the storage device 260 through dedicated interfaces.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to the cell coverage of the first base station 110-1. Also, the second terminal 130-2, the fourth terminal 130-4, and the fifth terminal 130-5 may belong to the cell coverage of the second base station 110-2. Also, the fifth base station 120-2, the fourth terminal 130-4, the fifth terminal 130-5, and the sixth terminal 130-6 may belong to the cell coverage of the third base station 110-3. Also, the first terminal 130-1 may belong to the cell coverage of the fourth base station 120-1, and the sixth terminal 130-6 may belong to the cell coverage of the fifth base station 120-2.

Here, each of the plurality of base stations 110-1, 110-2, 110-3, 120-1, and 120-2 may be referred to as NodeB (NB), evolved NodeB (eNB), 5G Node B (gNB), base transceiver station (BTS), radio base station, radio transceiver, access point (AP), access node, road side unit (RSU), digital unit (DU), cloud digital unit (CDU), radio remote head (RRH), radio unit (RU), transmission point (TP), transmission and reception point (TRP), relay node, or the like. Each of the plurality of terminals 130-1, 130-2, 130-3, 130-4, 130-5, and 130-6 may be referred to as terminal, access terminal, mobile terminal, station, subscriber station, mobile station, portable subscriber station, node, device, or the like.

Each of the plurality of communication nodes 110-1, 110-2, 110-3, 120-1, 120-2, 130-1, 130-2, 130-3, 130-4, 130-5, and 130-6 may support cellular communication (e.g., LTE, LTE-Advanced (LTE-A), New Radio (NR), etc.). Each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul link or a non-ideal backhaul link, and exchange information with each other via the ideal or non-ideal backhaul. Also, each of the plurality of base stations 110-1, 110-2, 110-3, 120-1, and 120-2 may be connected to the core network through the ideal backhaul link or non-ideal backhaul link. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

Each of the plurality of base stations 110-1, 110-2, 110-3, 120-1, and 120-2 may support OFDMA-based downlink (DL) transmission, and SC-FDMA-based uplink (UL) transmission. In addition, each of the plurality of base stations 110-1, 110-2, 110-3, 120-1, and 120-2 may support a multi-input multi-output (MIMO) transmission (e.g., single-user MIMO (SU-MIMO), multi-user MIMO (MU-MIMO), massive MIMO, or the like), a coordinated multipoint (CoMP) transmission, a carrier aggregation (CA) transmission, a transmission in unlicensed band, a device-to-device (D2D) communication (or, proximity services (ProSe)), an Internet of Things (IoT) communication, a dual connectivity (DC), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e., the operations supported by the plurality of base stations 110-1, 110-2, 110-3, 120-1, and 120-2).

Meanwhile, the present disclosure provides an improved reporting method and apparatus of a terminal, wherein the terminal reports a measurement result or measure prediction measurement result to a base station when occurrence of a specific event is identified based on the measurement result or measurement prediction result of the terminal in a mobile communication system. In addition, the present disclosure provides an improved reporting method and apparatus of a terminal, which enhance performance by enabling a base station to manage mobility of the terminal more accurately based on the measurement result or measurement prediction result of the terminal.

In a New Radio (NR) system, a base station may configure a terminal in a connected state to report a Layer 1 (L1) measurement result for beam-level mobility management. The base station may configure the terminal with synchronization signal block (SSB) resources or channel state information (CSI) resources to measure and report the L1 measurement result periodically. Alternatively, the base station may configure the terminal with SSB or CSI resources to measure and report the L1 measurement result semi-persistently. Alternatively, the base station may configure the terminal with SSB or CSI resources to measure and report the L1 measurement result upon receiving a request from the base station. Here, the SSB or CSI resources may be reference signal resources.

Based on report configuration information, the terminal may report an L1-reference signal received power (L1-RSRP) measurement result of the best SSB or CSI resource to the base station. Alternatively, based on report configuration information, the terminal may report an L1-RSRP measurement result of the top-K SSB or CSI resources in order of quality to the base station, where K is a positive integer. The base station may receive the report of the measurement result from the terminal.

Upon receiving the measurement result, the base station may allocate an optimal beam to the terminal and transmit data through the allocated beam. In this case, the terminal may frequently report a beam measurement result to the base station. Consequently, the base station may frequently receive the latest beam measurement result from the terminal, increasing a likelihood of allocating the optimal beam. However, signaling overhead may increase due to the terminal's frequent reporting. Conversely, the terminal may occasionally report a beam measurement result to the base station, reducing the signaling overhead. However, if the base station receives the latest beam measurement result from the terminal infrequently, a likelihood of allocating the optimal beam may decrease.

In the NR system, the base station may configure a terminal in a connected state to report an L1 measurement result for inter-cell L1/Layer 2 (L2)-triggered mobility (LTM) management. The base station may configure the terminal with LTM-CSI resources to measure and report the L1 measurement result periodically or semi-persistently.

Based on report configuration information, the terminal may report L1-RSRP measurement results of LTM-CSI resources of LTM candidate cell(s) in order of quality. Upon receiving the L1-RSRP measurement results, the base station may determine a target cell and transmit an LTM cell switch command to the terminal. As described above, the terminal may report the L1 measurement result to the base station periodically or semi-persistently. In this case, the terminal may frequently report the L1 measurement result to the base station.

Accordingly, the base station may frequently receive the latest L1 measurement result from the terminal, increasing a likelihood of allocating a beam corresponding to an LTM-CSI resource of an optimal LTM candidate cell. However, signaling overhead may increase due to frequent reporting. Furthermore, as the terminal uses the L1 measurement result without filtering, the terminal may connect to a target cell for a short period and then perform a handover to another cell, including a source cell. This may result in frequent handovers, further increasing signaling overhead.

In the NR system, the base station may configure a terminal in a connected state to report a cell-level measurement result for inter-cell Layer 3 (L3) mobility management. The base station may configure the terminal to report the cell-level measurement result periodically or when a specific event occurs.

The base station may configure a measurement reporting event that is satisfied when an A3 event occurring when a signal strength measurement result of a specific neighboring cell better than a serving cell by a certain offset remains for a time-to-trigger (TTT) duration. In this case, if the base station configures the offset or TTT with a small value, the base station can improve a user's perceived transmission speed. However, the small offset or TTT may cause frequent handovers, increasing interruption time. Conversely, if the base station configures the offset or TTT with a large value, the base station can reduce a frequency of handovers, thereby decreasing interruption time. However, the large offset or TTT may delay a handover to a better cell, potentially reducing the user's perceived transmission speed.

To address the above-described issues, the present disclosure is directed to providing a beam measurement result reporting method and apparatus that frequently report a beam measurement result in a situation where the optimal beam changes frequently, and occasionally report a beam measurement result in a situation where the optimal beam changes infrequently. This reduces signaling overhead while increasing a likelihood of allocating the optimal beam. Furthermore, the present disclosure is directed to providing a cell-level measurement result reporting method and apparatus that reduce handover frequency and interruption time while enabling faster handover to a better cell, thereby improving the user's perceived transmission speed.

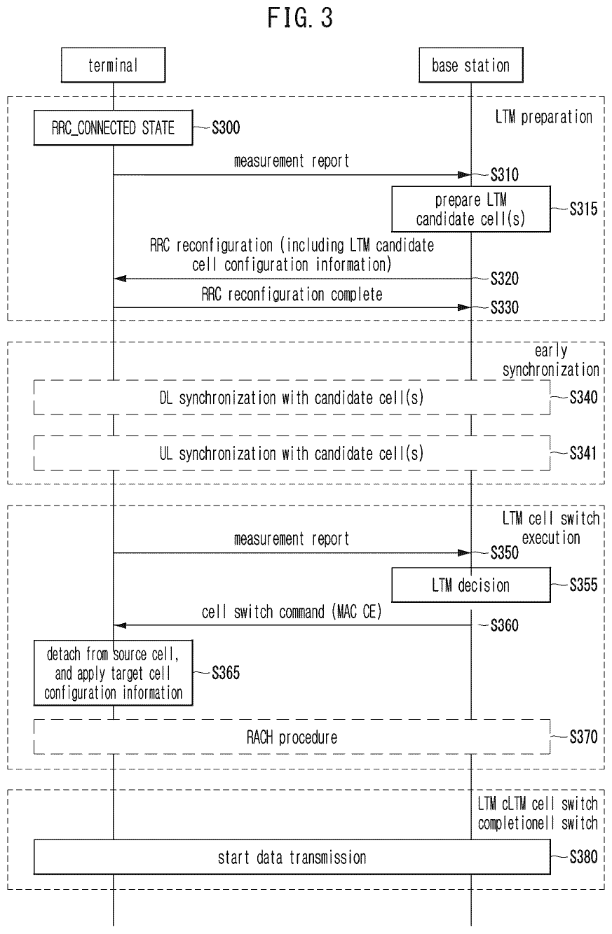

FIG. 3 is a sequence chart illustrating exemplary embodiments of an L1/L2-based mobility management method.

Referring to FIG. 3, the L1/L2-based mobility management method may comprise an LTM preparation procedure, an early synchronization procedure, an LTM cell switch execution procedure, and an LTM cell switch completion procedure. A radio resource control (RRC) connection between a base station and a terminal may be assumed to be an RRC connected state (i.e. RRC_CONNECTED state).

During the LTM preparation procedure of the LTM procedure, steps S300 to S330 may be performed. In steps S300 to S330, the terminal may be in the RRC_CONNECTED state with the base station (S300). The terminal may transmit a measurement report message (e.g. MeasurementReport message) to the base station to report a signal strength measurement result of a serving cell and neighboring cell(s) (S310). The base station may prepare LTM candidate cell(s) based on the reported signal strength measurement result (S315). The base station may transmit an RRC reconfiguration message (e.g. RRCReconfiguration message) to the terminal to provide configuration information of the prepared LTM candidate cell(s). The terminal may receive the RRC reconfiguration message and store the configuration information of the LTM candidate cell(s) (S320). Additionally, the terminal may transmit an RRC reconfiguration complete message (e.g. RRCReconfigurationComplete message) to the base station in response to the RRC reconfiguration message (S330).

During the early synchronization procedure of the LTM procedure, the terminal may acquire downlink (DL) synchronization with the LTM candidate cell(s) before receiving an LTM cell switch command message to reduce interruption time (S340). Additionally, the terminal may perform an uplink (UL) synchronization acquisition procedure with the LTM candidate cell(s) before receiving the LTM cell switch command message to reduce interruption time (S341).

In the LTM cell switch execution procedure of the LTM procedure, steps S350 to S370 may be performed. In steps S350 to S370, the terminal may perform signal strength measurement for the LTM candidate cell(s) and transmit an L1 signal strength measurement result report message to the base station. The terminal may continuously perform L1 measurement while the candidate cell(s) are configured and report the L1 measurement result to the base station periodically or semi-persistently according to L1 measurement result report configuration information. The base station may receive the L1 signal strength measurement result report message from the terminal (S350). Based on L1 signal strength measurement result of the terminal received in step S350, the base station may determine an LTM candidate cell to be changed to a target cell (S355). The base station may transmit a cell switch command to the terminal through a MAC control element (CE) (S360). The cell switch command message may include uplink synchronization information for the target cell. Subsequently, the terminal may detach from the source cell and apply the preconfigured LTM candidate cell configuration information (S365). The terminal may attempt to connect to the target cell by using the candidate cell as the target cell. If the UL synchronization is invalid, the terminal may perform a random access procedure to acquire UL synchronization (S370). During the LTM cell switch completion procedure of the LTM procedure, the terminal may notify a target base station that the connection to the target cell has been successfully completed. The base station may then start data transmission to the terminal (S380).

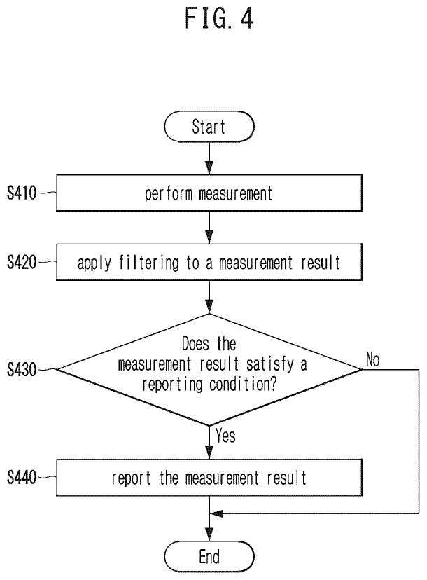

FIG. 4 is a flow chart illustrating exemplary embodiments of a measurement result reporting method in a communication system.

Referring to FIG. 4, during the LTM preparation procedure of the L1/L2-based mobility management method, the base station may generate measurement configuration information for SSB resources or CSI resources of the serving cell or candidate cell(s) to enable measurement by the terminal and transmit the measurement configuration information to the terminal. The terminal may receive the measurement configuration information for SSB resources or CSI resources of the serving cell or candidate cell(s) from the base station. Here, the SSB resources or CSI resources may be reference signal resources.

During the LTM preparation procedure of the LTM procedure in the L1/L2-based mobility management method, the terminal may receive and configure the measurement configuration information for SSB resources or CSI resources of the serving cell or candidate cell(s) from the base station. Subsequently, the terminal may perform measurement on the SSB resources or CSI resources according to the configured measurement configuration information (S410). As described above, during the LTM preparation procedure of the LTM procedure, the base station may generate signal strength measurement configuration information for the SSB resources or CSI resources of the serving cell and candidate cell(s) based on the terminal's capability, network configuration information, and the like. The base station may transmit the signal strength measurement configuration information to the terminal. Accordingly, the terminal may receive the measurement configuration information from the base station. Based on the measurement configuration information, the terminal may measure received signal strengths of the SSB resources or CSI resources of the serving cell and candidate cell(s) (e.g. Reference Signal Received Power (RSRP), Reference Signal Received Quality (RSRQ), or Signal-to-Interference-plus-Noise Ratio (SINR), etc.).

The terminal may apply L1 filtering to the measurement result and use the L1-filtered measurement result as the measurement result (S420). By applying L1 filtering to the L1 measurement result, the terminal may report a trend in measurement results, which is less sensitive to momentary changes, to the base station. This approach may prevent frequent handovers and reduce signaling overhead.

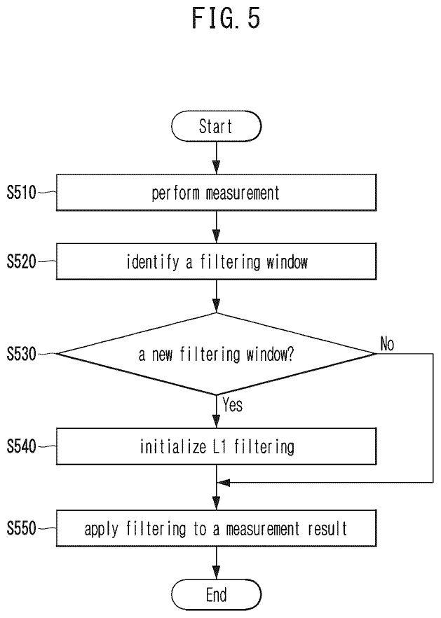

The terminal may determine whether the L1-filtered measurement result satisfies a reporting condition (S430). If the L1-filtered measurement result satisfies the reporting condition, the terminal may report the L1-filtered measurement result to the base station (S440). The base station may receive the L1-filtered measurement result from the terminal. By configuring the terminal to report the L1-filtered L1 measurement result only when the specific reporting condition is satisfied, the terminal can quickly report a critical measurement result for handover decision to the base station. This allows the terminal to report the latest beam measurement result to the base station while minimizing signaling overhead. Conversely, if the L1-filtered measurement result does not satisfy the specific reporting condition, the terminal may terminate the process. FIG. 5 is a flow chart illustrating exemplary embodiments of the measurement method and filtering method of FIG. 4.

Referring to FIG. 5, after the LTM preparation procedure of the LTM procedure in the L1/L2-based mobility management method, the terminal may perform measurement on the configured SSB resources or CSI resources (S510). During the LTM preparation procedure of the LTM procedure, the base station may generate signal strength measurement configuration information for the SSB resources or CSI resources of the serving cell and candidate cell(s) based on the terminal's capability, network configuration information, and the like. Then, the base station may transmit the signal strength measurement configuration information to the terminal. Accordingly, the terminal may receive the measurement configuration information from the base station. Based on the measurement configuration information, the terminal may measure received signal strengths of the SSB resources or CSI resources of the serving cell and candidate cell(s) (e.g. RSRP, RSRQ, SINR, etc.).

The terminal may identify a filtering window (S520). Based on a result of filtering window identification, the terminal may determine whether a new filtering window has started at a time of identification (S530). If the terminal determines that a new filtering window has started at the time of identification, the terminal perform initialization of L1 filtering (S540). The terminal may apply the L1 filtering to the measurement result based on the new filtering window and use the L1-filtered measurement result as the measurement result (S550). Conversely, if the terminal determines that no new filtering window has started at the time of identification, the terminal may apply L1 filtering to the measurement result based on the currently-used filtering window and use the L1-filtered measurement result as the measurement result (S550).

The terminal may maintain a balance between optimal beam allocation and handover frequency by applying the filtering window. Furthermore, the terminal may indicate a trend in L1 measurement results by using an L1-filtered measurement result derived from the previous filtering window. Additionally, the terminal may assign a greater weight to the recent L1 measurement result, increasing a likelihood of allocating the optimal beam.

The terminal may determine whether the L1-filtered measurement result satisfies a reporting condition. If the L1-filtered measurement result is determined to satisfy the reporting condition, the terminal may report the L1-filtered measurement result to the base station. The base station may receive the L1-filtered measurement result from the terminal. By configuring the terminal to report the L1-filtered L1 measurement result only when the specific reporting condition is satisfied, the terminal can quickly report a critical measurement result for handover decision to the base station. This allows the terminal to report the latest beam measurement result to the base station while minimizing signaling overhead. Conversely, if the L1-filtered measurement result is determined not to satisfy the specific reporting condition, the terminal may terminate the process.

The filtering process described with reference to FIG. 5 may allow the terminal to maintain a balance between optimal beam allocation and handover frequency by applying the filtering window. The base station may determine the size of the filtering window and transmit information on the determined filtering window size to the terminal. Accordingly, the terminal may receive the information on the filtering window size from the base station and configure the filtering window based on the received information on the filtering window size. The size of the filtering window may be represented as a specific time. For example, the filtering window size may be configured as 0 ms, 100 ms, 200 ms, or 1000 ms.

As another method, the size of the filtering window may be represented as the number of L1 measurement samples. For example, the filtering window size may be configured as 1 measurement sample, 4 measurement samples, 8 measurement samples, 16 measurement samples, or the like. When the filtering window size is configured as a specific time of 0 ms or 1 sample, a filtered measurement result may be identical to an actual measurement result. The terminal may apply L1 filtering to the L1 measurement result obtained after the filtering window is configured. The base station may update the filtering window size to maintain a balance between optimal beam allocation and handover frequency and configure the updated filtering window size to the terminal.

Equation 1 below may represent a method of L1 filtering performed by the terminal. N L1 measurement samples may exist within a single filtering window. Here, Mn represents the N-th L1 measurement result. An may represent the N-th filtered L1 measurement result. Here, N may be positive integers.

$$An = ( M 1 + … + Mn ) / N \qquad [ Equation 1 ]$$

The terminal may further reflect the L1-filtered L1 measurement result derived from the previously used filtering window into the current L1 measurement result. To this end, the base station may instruct the terminal to reflect the L1-filtered L1 measurement result derived from the previously used filtering window into the current L1 measurement result. The terminal may receive the instruction from the base station, and configure the L1-filtered L1 measurement result derived from the previously used filtering window to be reflected into the current L1 measurement result according to the instruction. Equation 2 below may represent a method for the terminal to perform L1 filtering by reflecting the L1-filtered L1 measurement result derived from the previously used filtering window based on the configuration.

In this case, N L1 measurement samples may exist within a single filtering window. Here, Mn represents the N-th L1 measurement result. An may represent the N-th filtered L1 measurement result. Here, N may be positive integers. An_pw may represent the N-th filtered L1 measurement result of the previous filtering window.

$$An = ( An\_pw + M 1 + … + Mn ) / ( N + 1 ) \qquad [ Equation 2 ]$$

The terminal may increase the likelihood of optimal beam allocation by assigning a weight to the recent L1 measurement result. The base station may determine the weight to be applied to the recent L1 measurement result and configure the weight to the terminal. Equation 3 below may represent a method of L1 filtering that applies the weight to the recent L1 measurement result. N L1 measurement samples may exist within the filtering window. Mn may represent the N-th L1 measurement result. An may represent the N-th filtered L1 measurement result. A1 may be set to M1. a may represent the weight applied to the recent L1 measurement result and may be a real number. Here, N may be positive integers.

$$An = ( 1 - a ) \times An - 1 + a \times Mn , A 1 = M 1 \qquad [ Equation 3 ]$$

The terminal may indicate a trend in L1 measurement results by reflecting an L1-filtered result derived from the previous filtering window to the L1 filtering method that applies the weight to the recent L1 measurement result. The base station may configure the terminal to reflect the filtered L1 measurement result derived from the previous filtering window. Equation 4 below may represent a method of L1 filtering that applies the weight to the recent L1 measurement result and reflects the filtered L1 measurement result derived from the previous filtering window. N L1 measurement samples may exist within a filtering window. Mn may represent the N-th L1 measurement result. An may represent the N-th filtered L1 measurement result. A1 may be set according to Equation 5 below. An_pw may represent the N-th filtered L1 measurement result from the previous filtering window. b may represent the weight to be applied to the N-th filtered L1 measurement result from the previous filtering window and may be a real number. a may represent the weight to be applied to the recent L1 measurement result and may also be a real number.

$$An = ( 1 - a ) \times An - 1 + a \times Mn \qquad [ Equation 4 ]$$

$$A 1 = b \times An\_pw + ( 1 - b ) \times M 1 \qquad [ Equation 5 ]$$

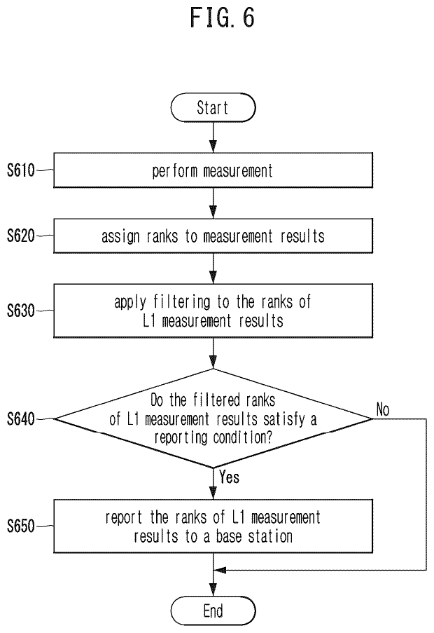

FIG. 6 is a flow chart illustrating exemplary embodiments of a measurement reporting method in a communication system.

Referring to FIG. 6, during the LTM cell switch execution procedure of the L1/L2-based mobility management method, the terminal may perform measurement on configured SSB/CSI resources for a predetermined duration at a predefined periodicity (S610). The terminal may rank L1 measurement results in order of quality (S620). In this case, the terminal may select the top-k measurement results and rank the selected L1 measurement results. The base station may determine a value of k and notify the value of k to the terminal, and the terminal may receive the value of k from the base station and recognize the value of k. Here, k may be a positive integer.

The terminal may apply configured L1 filtering to the top-k ranked L1 measurement results (S630). By applying L1 filtering to the ranks of the L1 measurement results, the terminal may reduce sensitivity to momentary changes in the ranks of the measurement results and ensure that a trend in measurement result ranks is reported. This approach may reduce the occurrence of frequent handovers, thereby reducing signaling overhead.

The terminal may determine whether the L1-filterd ranks of the L1 measurement results satisfy a specific reporting condition for measurement result rank reporting (S640). If the L1-filtered ranks of the L1 measurement results satisfy the specific reporting condition, the terminal may report the L1-filtered ranks of the L1 measurement results to the base station (S650). In this case, the terminal may also report the corresponding measurement results to the base station. The base station may receive the L1-filtered ranks of the L1 measurement results from the terminal and also receive the corresponding measurement results from the terminal.

The terminal may perform reporting when the L1-filterd ranks of the L1 measurement results satisfy the specific reporting condition, thereby quickly reporting critical measurement results for handover decision to the base station. This approach allows the terminal to report the latest beam measurement result to the base station while minimizing signaling overhead. Conversely, if the L1-filtered ranks of the L1 measurement results do not satisfy the specific reporting condition, the terminal may terminate the process.

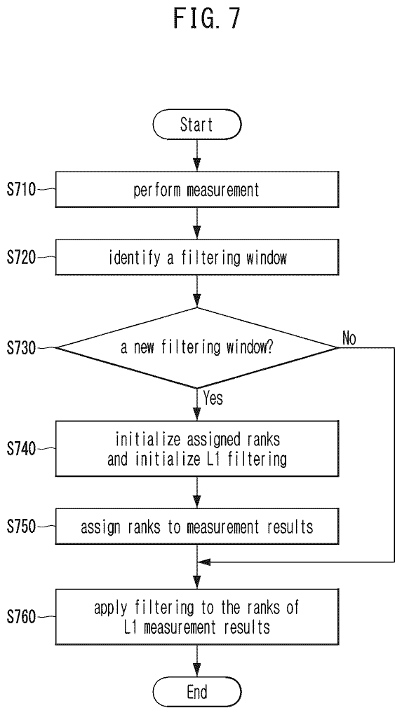

FIG. 7 is a flow chart illustrating exemplary embodiments of the method for ranking measurement results and applying filtering in FIG. 6.

Referring to FIG. 7, during the LTM cell switch execution procedure of the L1/L2-based mobility management method, the terminal may perform measurement on configured SSB/CSI resources (S710). In many cases where the L1 measurement result is utilized, an SSB/CSI resource identifier corresponding to the best L1 measurement result may be more important than an actual L1 measurement value. The terminal may identify a filtering window (S720). The terminal may determine whether a new filtering window has started based on a result of the identification (S730).

If the terminal determines that a new filtering window has started, the terminal may initialize L1 filtering and ranks assigned to measurement results (S740). The terminal may rank the measurement results in order of quality (S750). The terminal may calculate an average over a time period configured by the filtering window by applying the L1 filtering to a rank of the L1 measurement result, and use the average as the rank of the L1 measurement result (S760).

Conversely, if the terminal determines that a new filtering window has not started, the terminal may calculate an average over a time period configured by the filtering window by applying L1 filtering based on the previous filtering window, and use the average as the rank of the L1 measurement result (S760). In the above-described manner, the terminal may maintain a balance between optimal beam allocation and handover frequency by applying the filtering window.

The terminal may determine whether the L1-filtered ranks of the L1 measurement results satisfy a specific reporting condition for measurement result rank reporting (S640). If the L1-filtered ranks of the L1 measurement results satisfy the specific reporting condition, the terminal may report the L1-filtered ranks of the L1 measurement results to the base station (S650). In this case, the terminal may also report the corresponding measurement results to the base station. The base station may receive the L1-filtered ranks of the L1 measurement results from the terminal and also receive the corresponding measurement results from the terminal.

The terminal may perform reporting when the L1-filtered ranks of the L1 measurement results satisfy the specific reporting condition, thereby quickly reporting critical measurement results for handover decision to the base station. This approach allows the terminal to report the latest beam measurement result to the base station while minimizing signaling overhead. Conversely, if the L1-filtered ranks of the L1 measurement results do not satisfy the specific reporting condition, the terminal may terminate the process.

The measurement reporting method described with reference to FIG. 7 may allow the terminal to maintain a balance between optimal beam allocation and handover frequency by applying the filtering window. The base station may determine the size of the filtering window and transmit information on the determined filtering window size to the terminal. The size of the filtering window may be represented as a specific time. For example, the filtering window size may be configured as 0 ms, 100 ms, 200 ms, or 1000 ms.

As another method, the size of the filtering window may be represented as the number of L1 measurement samples. For example, the filtering window size may be configured as 1 measurement sample, 4 measurement samples, 8 measurement samples, 16 measurement samples, or the like. When the filtering window size is configured as a specific time of 0 ms or 1 sample, a filtered measurement result may be identical to an actual measurement result. The terminal may apply L1 filtering to the L1 measurement result obtained after the filtering window is configured. The base station may update the filtering window size to maintain a balance between optimal beam allocation and handover frequency and configure the updated filtering window size to the terminal.

Equation 6 below may represent a method of L1 filtering applied to the ranks of L1 measurement results. N L1 measurement samples may exist within the filtering window. Rm may represent a rank of the M-th L1 measurement result. Tn may represent an L1-filtered rank of the N-th L1 measurement result. The value of Rm may be configured such that Tn increases as the L1 measurement result is better. As one example, if the rank of the corresponding L1 measurement result is within the top-k ranks, Rm may be set to A, and otherwise, Rm may be set to 0. As another method, if the rank of the corresponding L1 measurement result is within the top-k ranks, Rm may be set to (k+1-rank), and otherwise, Rm may be set to 0. Here, M, A and k may be positive integers.

$$Tn = 1 / N \times ( R 1 + … + Rn ) , Rm = A ( A > 0 ) , \\ if Top - k ( k = 1 , 2 , … ) , Rm = 0 , others \qquad [ Equation 6 ]$$

Equation 7 below may represent another method of L1 filtering applied to the ranks of L1 measurement results. As another method, the value of Rm may be configured such that Tn decreases as the L1 measurement result is better. As one example, Rm may be set to 0 if a rank of the corresponding L1 measurement result is within the top-k ranks, and otherwise, Rm may be set to B. As another method, Rm may be set to (rank-1) if the rank of the corresponding L1 measurement result is within the top-k ranks, and otherwise, Rm may be set to B. Here, B may be positive integers.

$$Rm = 0 , if Top - k ( k = 1 , 2 , … ) , Rm = B ( B > 0 ) , others \qquad [ Equation 7 ]$$

The terminal may reflect a trend in the ranks of the L1 measurement results by using the filtered ranks of the L1 measurement results derived from the previous filtering window. The base station may configure the terminal to reflect the ranks of the filtered L1 measurement results of the previous filtering window. Equation 8 below may represent a method of L1 filtering that reflects the ranks of the filtered L1 measurement results of the previous filtering window. N L1 measurement samples may exist within the filtering window. Rm may represent a rank of the M-th L1 measurement result. Tn may represent an L1-filtered rank of the N-th L1 measurement result. Tn_pw may represent a filtered rank of the N-th L1 measurement result of the previous filtering window.

$$Tn = 1 / ( N + 1 ) \times ( Tn\_pw + R 1 + … + Rn ) \qquad [ Equation 8 ]$$

Not only whether a rank of an L1 measurement result is within the top-k ranks, but also the rank itself may be importantly utilized. To this end, the base station may configure the terminal to consider weights for the top-k ranks. Equation 9 below may represent a method of L1 filtering applied to the ranks of L1 measurement results. N L1 measurement samples may exist within the filtering window. Rm may represent a rank of the M-th L1 measurement result. Tn may represent a filtered rank of the N-th L1 measurement result. Rm may be set to wj if the corresponding L1 measurement result is within the top k, and otherwise, Rm may be set to 0. Here, j may be an actual rank value, and wj may be set as follows. In this case, the base station may determine a value of C and configure the value of C to the terminal. Alternatively, the terminal may use a predefined value of wj. Here, j and C may be positive integers.

$$Rm = wj , if Top - k ( k = 1 , 2 , … ) , \\ wj = 1 / j \times C ( j <= k ) , Rm = 0 , others \qquad [ Equation 9 ]$$

As another method, the terminal may configure the value of Rm such that Tn decreases as the L1 measurement result is better, as shown in Equation 10. As one example, Rm may be set to j if the corresponding L1 measurement result is within the top-k ranks, and otherwise, Rm may be set to D. Here, j may be the actual rank value. As another method, the terminal may use a predefined value of wj. Here, D may be positive integers.

$$Rm = wj = j , if Top - k ( k = 1 , 2 , … ) , \\ Rm = D ( D >= k ) , others \qquad [ Equation 10 ]$$

The terminal may assign a weight to the rank of the recent L1 measurement result to increase a likelihood of allocating the optimal beam. The base station may determine the weight to be applied to the rank of the recent L1 measurement result and configure the weight to the terminal. Equation 11 below may represent a method of L1 filtering that uses the weight applied to the rank of the recent L1 measurement result. N L1 measurement samples may exist within the filtering window. Rm may represent a rank of the M-th L1 measurement result. Tn may represent a filtered rank of the N-th L1 measurement result. T1 may be set to R1. a may represent the weight applied to the rank of the recent L1 measurement result and may be a real number.

$$Tn = ( 1 - a ) \times Tn - 1 + a \times Rn , T 1 = R 1 \qquad [ Equation 11 ]$$

As shown in Equation 12, the terminal may indicate a trend in the ranks of the L1 measurement results by reflecting the filtered ranks of the L1 measurement results derived from the previous filtering window into the L1 filtering method applying the weight to the rank of the recent L1 measurement result. To this end, the base station may configure the terminal to reflect the filtered ranks of the L1 measurement results derived from the previous filtering window. Equation 12 below may represent a method of L1 filtering that applies the weight to the rank of the recent L1 measurement result and reflects the filtered ranks of the L1 measurement results derived from the previous filtering window. N L1 measurement samples may exist within the filtering window.

Rm may represent a rank of the M-th L1 measurement result. Tn may represent a filtered rank of the N-th L1 measurement result. Tn may be set as shown in Equation 12, and T1 may be set to R1 as shown in Equation 13. a may represent the weight applied to the rank of the recent L1 measurement result and may be a real number. Tn_pw may represent a filtered rank of the N-th L1 measurement result of the previous filtering window. b may represent the weight to be applied to the filtered rank of the N-th L1 measurement result of the previous filtering window. a may represent the weight to be applied to the rank of the recent L1 measurement result.

$$Tn = ( 1 - a ) \times Tn - 1 + a \times Rn \qquad [ Equation 12 ]$$

$$T 1 = b \times Tn\_pw + ( 1 - b ) \times R 1 \qquad [ Equation 13 ]$$

Meanwhile, the base station may configure the terminal to report L1-filtered L1 measurement results when a specific reporting condition is met. Here, the specific reporting condition may correspond to the reporting condition of FIG. 4 or may correspond to a specific event condition. The specific event condition may, for example, be as shown in Equation 14. In Equation 14, Ac may represent an L1-filtered L1 measurement result for an SSB resource or CSI resource of a candidate cell. As may represent an L1-filtered L1 measurement result for an SSB resource or CSI resource of a serving cell. offset1 may represent an additional offset value configured to reduce frequent handovers. The base station may determine a value of offset1 and configure the value of offset 1 to the terminal. The terminal may receive the value of offset1 from the base station. When the specific event condition expressed by Equation 14 is satisfied, the terminal may report the L1 measurement result to the base station. Additionally, the base station may configure the terminal with other event conditions.

$$Ac \geq As + offset 1 \qquad [ Equation 14 ]$$

Meanwhile, the base station may configure the terminal to report L1-filtered ranks of L1 measurement results when a specific reporting condition is satisfied. Here, the specific reporting condition may correspond to the reporting condition shown in FIG. 6. The specific reporting condition may correspond to a specific event condition. As an example, the specific event condition may correspond to Equation 15 below. In Equation 15, Tc may represent an L1-filtered rank of an L1 measurement result for an SSB resource or CSI resource of a candidate cell. Ts may represent an L1-filtered rank of an L1 measurement result for an SSB resource or CSI resource of a current serving cell. offset2 may be an additional offset value configured to reduce frequent handovers. The base station may determine a value of offset2 and configure the value of offset2 to the terminal.

$$Tc \geq Ts + offset 2 \qquad [ Equation 15 ]$$

As another method, the terminal may configure such that Tn decreases as the L1 measurement result is better. The specific event condition may correspond to Equation 16 below. Here, Tc may represent the L1-filtered rank of the L1 measurement result for the SSB resource or CSI resource of the candidate cell. Ts may represent the L1-filtered rank of the L1 measurement result for the SSB resource or CSI resource of the current serving cell. offset3 may be an additional offset value configured to reduce frequent handovers. The base station may determine a value of offset3 and configure the value of offset3 to the terminal. Additionally, the base station may configure other event conditions.

$$Tc + offset 3 \leq Ts \qquad [ Equation 16 ]$$

Meanwhile, when reporting the ranks of the L1 measurement results, the corresponding L1 measurement results may also be reported. As another method, the terminal may report only the L1 measurement results based on the ranks of the L1 measurement results. For example, when reporting the L1 measurement results, the terminal may report L1 measurement results of L SSB resources or CSI resources in descending order of rank. The base station may determine a value of L and configure the value of L to the terminal. As another method, the terminal may use a predefined value of L. L may be a positive integer.

For example, when reporting the ranks of the L1 measurement results, the terminal may report, to the base station, L1 measurement results of M SSB resources or CSI resources in descending order of rank. The base station may determine a value of M and configure the value of M to the terminal. As another method, the terminal may use a predefined value of M. M may be a positive integer.

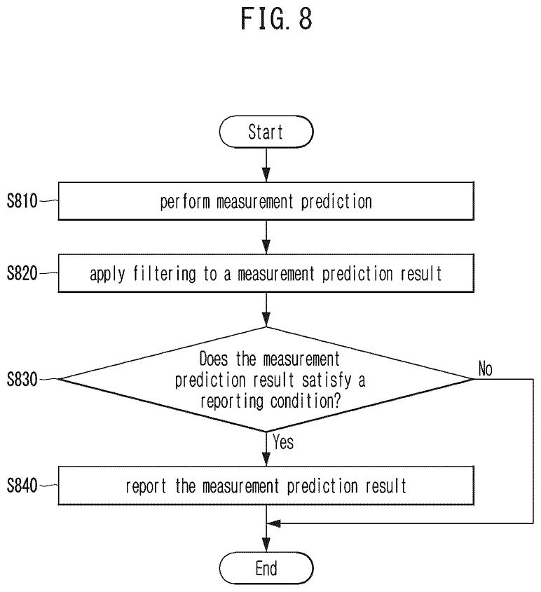

FIG. 8 is a flow chart illustrating exemplary embodiments of a measurement prediction reporting method in a communication system.

Referring to FIG. 8, during the LTM preparation procedure of the L1/L2-based mobility management method, the base station may generate measurement prediction configuration information for SSB resources or CSI resources of a serving cell or candidate cell(s) to facilitate measurement prediction by the terminal, and may transmit the measurement prediction configuration information to the terminal. The terminal may receive the measurement prediction configuration information from the base station. After the LTM preparation procedure of the L1/L2-based mobility management method, the terminal may perform measurement prediction for the configured SSB resources or CSI resources based on the received measurement prediction configuration information (S810). As described above, during the LTM preparation procedure, the base station may generate the measurement prediction configuration information for signal strengths of the SSB/CSI resources of the serving cell and candidate cell(s) based on the terminal's capability, network configuration information, and the like. The base station may transmit the measurement prediction configuration information to the terminal. Accordingly, the terminal may receive the measurement prediction configuration information from the base station. The terminal may perform measurement prediction for signal strengths (e.g. RSRP, RSRQ, or SINR) of the SSB resources or CSI resources of the serving cell and candidate cell(s) based on the measurement prediction configuration information. Here, the SSB resources or CSI resources may be reference signal resources.

For example, the terminal may perform measurement on the configured SSB resources or CSI resources. Based on the measurement results, the terminal may predict a measurement result at a specific time after a time of the measurement. The terminal may perform the prediction operation using artificial intelligence (AI) and/or machine learning (ML) devices or algorithms with a preconfigured deep neural network (DNN).

The terminal may apply L1 filtering to the measurement prediction result and use the L1-filtered measurement prediction result as the measurement prediction result (S820). In the above-described manner, the terminal may apply L1 filtering to the L1 measurement prediction result to report a trend in the measurement prediction results, which is less sensitive to momentary changes, to the base station. Through the L1 filtering, the terminal may prevent frequent handovers and reduce signaling overhead.

The terminal may determine whether the L1-filtered measurement prediction result satisfies a reporting condition (S830). If the L1-filtered measurement prediction result is determined to satisfy the reporting condition, the terminal may report the measurement prediction result to the base station (S840). The base station may receive the measurement prediction result from the terminal. In the above-described manner, the terminal may perform reporting of the L1-filtered L1 measurement prediction result when the specific condition is satisfied, enabling rapid reporting of the critical measurement prediction result necessary for handover decision to the base station. Through the above-described operation, the terminal may report the latest beam measurement prediction result to the base station while minimizing an increase in signaling overhead. Conversely, if the L1-filtered measurement prediction result is determined not to satisfy the reporting condition, the terminal may terminate the process.

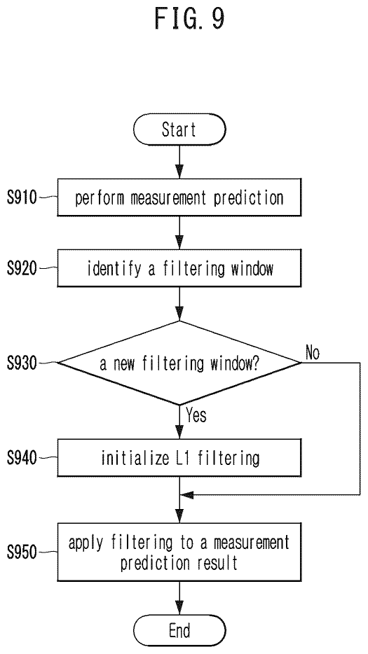

FIG. 9 is a flow chart illustrating exemplary embodiments of the measurement prediction method and filtering method in FIG. 8.

Referring to FIG. 9, during the LTM preparation procedure or LTM cell switch execution procedure of the L1/L2-based mobility management method, the terminal may perform measurement prediction for the configured SSB resources or CSI resources (S910). During the LTM preparation procedure of the LTM procedure, the base station may generate signal strength measurement prediction configuration information for the SSB resources or CSI resources of the serving cell and candidate cell(s) based on the terminal's capability, network configuration information, and the like. The base station may transmit the signal strength measurement prediction configuration information to the terminal. Accordingly, the terminal may receive the measurement prediction configuration information from the base station. Based on the measurement prediction configuration information, the terminal may measure and predict received signal strengths (e.g. RSRP, RSRQ, or SINR) for the SSB resources or CSI resources of the serving cell and candidate cell(s).

The terminal may identify a filtering window (S920). Based on a result of filtering window identification, the terminal may determine whether a new filtering window has started at a time of identification (S930). If the terminal determines that a new filtering window has started at the time of identification, the terminal perform initialization of L1 filtering (S940). The terminal may apply L1 filtering to measurement results based on the new filtering window and use the L1-filtered measurement result as the measurement result (S950). Conversely, if the terminal determines that no new filtering window has started at the time of identification, the terminal may apply L1 filtering to the measurement prediction result based on the currently-used filtering window and use the L1-filtered measurement prediction result as the measurement prediction result (S950).

The terminal may maintain a balance between optimal beam allocation and handover frequency by applying the filtering window. Furthermore, the terminal may indicate a trend in L1 measurement prediction results by reflecting the L1-filtered measurement prediction results derived from the previous filtering window. Additionally, the terminal may assign a greater weight to the recent L1 measurement prediction result, increasing a likelihood of allocating the optimal beam.

The terminal may determine whether the L1-filtered measurement prediction result satisfies a reporting condition. If the L1-filtered measurement prediction result satisfies the reporting condition, the terminal may report the L1-filtered prediction measurement result to the base station. The base station may receive the L1-filtered measurement prediction result from the terminal. By configuring the terminal to report the L1-filtered L1 measurement prediction result only when the specific reporting condition is satisfied, the terminal can quickly report a critical measurement prediction result for handover decision to the base station. This allows the terminal to report the latest beam measurement prediction result to the base station while minimizing signaling overhead. Conversely, if the L1-filtered measurement prediction result does not satisfy the specific reporting condition, the terminal may terminate the process.

The filtering process described with reference to FIG. 9 may allow the terminal to maintain a balance between optimal beam allocation and handover frequency by applying the filtering window. The base station may determine the size of the filtering window and transmit information on the determined filtering window size to the terminal. Accordingly, the terminal may receive the information on the filtering window size from the base station and configure the filtering window based on the received information on the filtering window size. The size of the filtering window may be represented as a specific time. For example, the filtering window size may be configured as 0 ms, 100 ms, 200 ms, or 1000 ms.

As another method, the size of the filtering window may be represented as the number of L1 measurement samples. For example, the filtering window size may be configured as 1 measurement sample, 4 measurement samples, 8 measurement samples, 16 measurement samples, or the like. When the filtering window size is configured as a specific time of 0 ms or 1 sample, a filtered measurement result may be identical to an actual measurement result. The terminal may apply L1 filtering to the L1 measurement result obtained after the filtering window is configured. The base station may update the filtering window size to maintain a balance between optimal beam allocation and handover frequency and configure the updated filtering window size to the terminal.

Equation 17 below may represent a method of L1 filtering performed by the terminal. N L1 measurement prediction samples may exist within a single filtering window. Here, Mn′ may represent the N-th L1 measurement prediction result. An′ may represent the N-th filtered L1 measurement prediction result. Here, N may be positive integers.

$${An}^{′} = ( M {1}^{′} + … + {Mn}^{′} ) / N \qquad [ Equation 17 ]$$

The terminal may additionally reflect the L1-filtered L1 measurement prediction results, which are calculated based on the previously used filtering window, in the current L1 measurement prediction result. To this end, the base station may instruct the terminal to reflect the L1-filtered L1 measurement prediction results, calculated based on the previously used filtering window, in the current L1 measurement prediction result. The terminal may receive the instruction from the base station and may configure the L1-filtered L1 measurement prediction results, calculated based on the previously used filtering window, to be reflected in the current L1 measurement prediction result according to the instruction. Equation 18 below may represent a method for the terminal to perform L1 filtering by reflecting the L1-filtered L1 measurement prediction results, calculated based on the previously used filtering window, according to the configuration.

In this case, N L1 measurement prediction samples may exist within a single filtering window. Here, Mn′ may represent the N-th L1 measurement prediction result. An′ may represent the N-th filtered L1 measurement prediction result. Here, N may be positive integers. AN,pw′ may represent the N-th filtered L1 measurement prediction result from the previous filtering window.

$${An}^{′} = ( {An\_pw}^{′} + M {1}^{′} + … + {Mn}^{′} ) / ( N + 1 ) \qquad [ Equation 18 ]$$

The terminal may increase a likelihood of allocating the optimal beam by applying a weight to the recent L1 measurement prediction result. The base station may determine the weight to be applied to the recent L1 measurement prediction result and configure the determined weight to the terminal. Equation 19 below may represent a method of L1 filtering that applies the weight to the recent L1 measurement result. N L1 measurement prediction samples may exist within a filtering window. Mn′ may represent the N-th L1 measurement prediction result. An′ may represent the N-th filtered L1 measurement prediction result. A1′ may be set to M1′. a′ may represent the weight to be applied to the recent L1 measurement prediction result and may be a real number.

Here, N may be positive integers.

$${An}^{′} = ( 1 - {a}^{′} ) \times An - {1}^{′} + {a}^{′} \times {Mn}^{′} , A {1}^{′} = M {1}^{′} \qquad [ Equation 19 ]$$

The terminal may indicate a trend in L1 measurement prediction results by reflecting the L1-filtered L1 measurement prediction results derived from the previous filtering window into the L1 filtering method applying the weight to the recent L1 measurement prediction result. The base station may configure the terminal to reflect the filtered L1 measurement prediction results of the previous filtering window. Equation 20 below may represent a method of L1 filtering that applies the weight to the recent L1 measurement prediction result and reflect the filtered L1 measurement prediction results of the previous filtering window. N L1 measurement prediction samples may exist within the filtering window. Mn′ may represent the N-th L1 measurement prediction result. An′ may represent the N-th filtered L1 measurement prediction result. A1′ may be configured according to Equation 21 below. An_pw′ may represent the N-th filtered L1 measurement prediction result from the previous filtering window. b′ may represent the weight to be applied to the N-th filtered L1 measurement prediction result from the previous window and may be a real number. a′ may represent the weight to be applied to the recent L1 measurement prediction result and may also be a real number.

$${An}^{′} = ( 1 - {a}^{′} ) \times An - {1}^{′} + {a}^{′} \times {Mn}^{′} \qquad [ Equation 20 ]$$

$$A {1}^{′} = {b}^{′} \times {An\_pw}^{′} + ( 1 - {b}^{′} ) \times M {1}^{′} \qquad [ Equation 21 ]$$

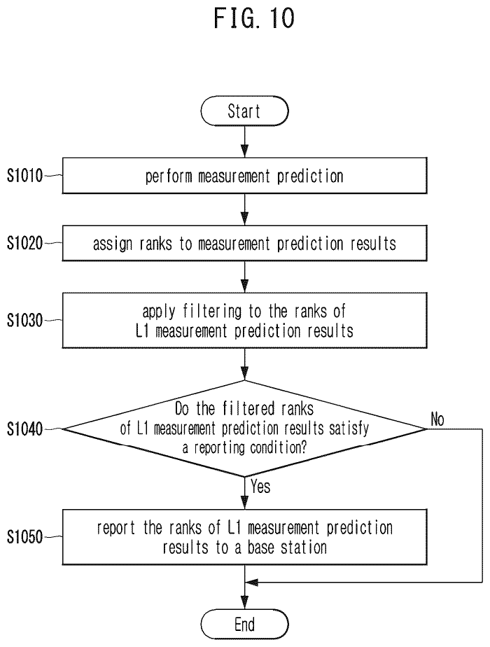

FIG. 10 is a flow chart illustrating exemplary embodiments of a measurement prediction reporting method in a communication system.

Referring to FIG. 10, during the LTM cell switch execution procedure of the L1/L2-based mobility management method, the terminal may perform measurement prediction on configured SSB/CSI resources for a predetermined duration at a predefined periodicity (S1010). The terminal may rank the L1 measurement prediction results in order of quality (S1020). In this case, the terminal may select the top-k measurement prediction results and rank the selected L1 measurement prediction results. The base station may determine a value of k and notify the value of k to the terminal, and the terminal may receive the value of k from the base station and recognize the value of k. Here, k may be a positive integer.

The terminal may apply configured L1 filtering to the top-k ranks of the L1 measurement prediction results (S1030). By applying L1 filtering to the ranks of the L1 measurement prediction results, the terminal may reduce sensitivity to momentary changes in the ranks of the measurement prediction results and ensure that a trend in the ranks of the measurement prediction results is reported. This approach may reduce the occurrence of frequent handovers, thereby reducing signaling overhead.

The terminal may determine whether the L1-filtered ranks of the L1 measurement prediction results satisfy a specific reporting condition for measurement prediction result rank reporting (S1040). If the L1-filtered ranks of the L1 measurement prediction results satisfy the specific reporting condition, the terminal may report the L1-filtered ranks of the L1 measurement prediction results to the base station (S1050). In this case, the terminal may also report the corresponding measurement prediction results to the base station. The base station may receive the ranks of the L1 measurement prediction results from the terminal and also receive the corresponding measurement prediction results from the terminal.

The terminal may perform reporting when the L1-filtered ranks of the L1 measurement prediction results satisfy the specific reporting condition, thereby quickly reporting a critical measurement result for handover decision to the base station. This approach allows the terminal to report the latest beam measurement prediction result to the base station while minimizing signaling overhead. Conversely, if the L1-filtered ranks of the L1 measurement prediction results do not satisfy the specific reporting condition, the terminal may terminate the process.

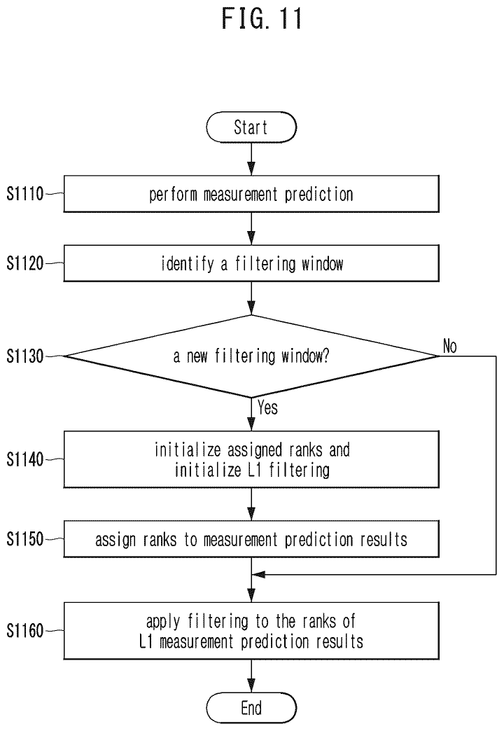

FIG. 11 is a flow chart illustrating exemplary embodiments of the method for ranking measurement prediction results and applying filtering in FIG. 10.

Referring to FIG. 11, during the LTM cell switch execution procedure of the L1/L2-based mobility management method, the terminal may perform measurement prediction on the configured SSB/CSI resources (S1110). In many cases where the L1 measurement prediction result is utilized, an SSB/CSI identifier corresponding to the best L1 measurement prediction result may be more important than an actual L1 measurement prediction value. The terminal may identify a filtering window (S1120). The terminal may determine whether a new filtering window has started based on a result of filtering window identification (S1130).

If the terminal determines that a new filtering window has started, the terminal may initialize L1 filtering and ranks assigned to measurement prediction results (S1140). The terminal may rank the measurement prediction results in order of quality (S1150). The terminal may calculate an average over a time period configured by the filtering window by applying the L1 filtering to a rank of the L1 measurement prediction result, and use the average as the rank of the L1 measurement prediction result (S1160).

Conversely, if the terminal determines that a new filtering window has not started, the terminal may calculate an average over a time period configured by the filtering window by applying L1 filtering based on the previous filtering window, and use the average as the rank of the L1 measurement prediction result (S1160). In the above-described manner, the terminal may maintain a balance between optimal beam allocation and handover frequency by applying the filtering window.

The terminal may determine whether the L1-filtered ranks of the L1 measurement prediction results satisfy a specific reporting condition for measurement prediction result rank reporting. If the L1-filtered ranks of the L1 measurement prediction results satisfy the specific reporting condition, the terminal may report the L1-filtered ranks of the L1 measurement prediction results to the base station. In this case, the terminal may also report the corresponding measurement prediction results to the base station. The base station may receive the L1-filtered ranks of the L1 measurement prediction results from the terminal and also receive the corresponding measurement prediction results from the terminal.

The terminal may perform reporting when the L1-filtered ranks of the L1 measurement prediction results satisfy the specific reporting condition, thereby quickly reporting critical measurement prediction results for handover decision to the base station. This approach allows the terminal to report the latest beam measurement prediction result to the base station while minimizing signaling overhead. Conversely, if the L1-filtered ranks of the L1 measurement prediction results do not satisfy the specific reporting condition, the terminal may terminate the process.

The measurement prediction reporting method described with reference to FIG. 11 may allow the terminal to maintain a balance between optimal beam allocation and handover frequency by applying the filtering window. The base station may determine the size of the filtering window and configure a filtering window to the terminal according to the determined filtering window size. The size of the filtering window may be represented as a specific time. For example, the filtering window size may be configured as 0 ms, 100 ms, 200 ms, or 1000 ms.

The measurement prediction reporting method described with reference to FIG. 11 may allow the terminal to maintain a balance between optimal beam allocation and handover frequency by applying the filtering window. The base station may determine the size of the filtering window and configure a filtering window to the terminal according to the determined filtering window size. The size of the filtering window may be represented as a specific time. For example, the filtering window size may be configured as 0 ms, 100 ms, 200 ms, or 1000 ms.

As another method, the size of the filtering window may be represented as the number of L1 measurement samples. For example, the filtering window size may be configured as 1 measurement sample, 4 measurement samples, 8 measurement samples, 16 measurement samples, or the like. When the filtering window size is configured as a specific time of 0 ms or 1 sample, a filtered measurement result may be identical to an actual measurement result. The terminal may apply L1 filtering to the L1 measurement result obtained after the filtering window is configured. The base station may update the filtering window size to maintain a balance between optimal beam allocation and handover frequency and configure the updated filtering window size to the terminal.

Equation 22 below may represent a method of L1 filtering applied to the ranks of L1 measurement prediction results. N L1 measurement prediction samples may exist within the filtering window. Rm′ may represent a rank of the M-th L1 measurement prediction result. Tn′ may represent an L1-filtered rank of the N-th L1 measurement prediction result. A value of Rm′ may be configured such that Tn′ increases as the L1 measurement prediction result is better. As an example, if the rank of the L1 measurement prediction result falls within the top-k ranks, Rm′ may be set to A. Otherwise, Rm′ may be set to 0. Here, M and A may be positive integers.

$${Tn}^{′} = 1 / N \times ( R {1}^{′} + … + {Rn}^{′} ) , {Rm}^{′} = A ( A > 0 ) , \\ if Top - k ( k = 1 , 2 , … ) , {Rm}^{′} = 0 , others \qquad [ Equation 22 ]$$

Equation 23 below may represent another method of L1 filtering applied to the ranks of the L1 measurement prediction results. Alternatively, the terminal may configure Rm′ such that Tn′ decreases as the L1 measurement prediction result is better. As an example, if the rank of the L1 measurement prediction result falls within the top-k ranks, Rm′ may be set to 0. Otherwise, Rm′ may be set to B. Here, B may be positive integers.

$${Rm}^{′} = 0 , if Top - k ( k = 1 , 2 , \text{…} ) , {Rm}^{′} = B ( B > 0 ) , others \qquad [ Equation 23 ]$$

The terminal may indicate a trend in the ranks of L1 measurement prediction results by reflecting the filtered ranks of the measurement prediction results derived from the previous filtering window. The base station may configure the terminal to reflect the filtered ranks of the L1 measurement prediction results of the previous filtering window. Equation 24 below may represent a method of L1 filtering that reflects the filtered ranks of the L1 measurement prediction results of the previous filtering window. N L1 measurement prediction samples may exist within the filtering window. Rm′ may represent a rank of the M-th L1 measurement prediction result. Tn′ may represent a filtered rank of the N-th L1 measurement prediction result. Tn_pw′ may represent a filtered rank of the N-th L1 measurement prediction result from of previous filtering window.

$${Tn}^{′} = 1 / ( N + 1 ) \times ( {Tn\_pw}^{′} + R {1}^{′} + … + {Rn}^{′} ) \qquad [ Equation 24 ]$$

Not only whether a rank of an L1 measurement prediction result is within the top-k ranks, but also the rank itself may be importantly utilized. To this end, the base station may configure the terminal to consider weights for the top-k ranks. Equation 25 below may represent a method of L1 filtering applied to the ranks of L1 measurement prediction results. N L1 measurement prediction samples may exist within the filtering window. Rm′ may represent a rank of the M-th L1 measurement prediction result. Tn′ may represent an L1-filtered rank of the N-th L1 measurement prediction result. Rm′ may be set to wj′ if the rank of the L1 measurement prediction result is within the top-k ranks. Otherwise, Rm′ may be set to 0. Here, j may represent an actual rank value, and wj′ may be set as follows. In this case, the base station may determine a value of C and configure the value of C to the terminal. As another method, the terminal may use a predefined value of wj′. Here, j and C may be positive integers.

$${Rm}^{′} = {wj}^{′} , if Top - k ( k = 1 , 2 , \text{…} ) , {wj}^{′} = 1 / j \times C ( j <= k ) , {Rm}^{′} = 0 , others \qquad [ Equation 25 ]$$

As another method, the terminal may configure Rm′ such that Tn′ decreases as the L1 measurement prediction result is better, as shown in Equation 26. As an example, Rm′ may be set to j if the rank of the L1 measurement prediction result is within the top-k ranks. Otherwise, Rm′ may be set to D. Here, j may represent the actual rank value. As another method, the terminal may use a predefined value of wj′. Here, D may be positive integers.

$${Rm}^{′} = {wj}^{′} = j , if Top - k ( k = 1 , 2 , \text{…} ) , \\ {Rm}^{′} = D ( D > = k ) , others \qquad [ Equation 26 ]$$

The terminal may assign a weight to the rank of the recent L1 measurement prediction result to increase a likelihood of allocating the optimal beam. The base station may determine the weight to be applied to the rank of the recent L1 measurement prediction result and configure the weight to the terminal. Equation 27 below may represent a method of L1 filtering that applies the weight to the rank of the recent L1 measurement prediction result. N L1 measurement prediction samples may exist within the filtering window. Rm′ may represent the rank of the M-th L1 measurement prediction result. Tn′ may represent the filtered rank of the N-th L1 measurement prediction result. T1′ may be set to R1′. a′ may represent the weight to be applied to the rank of the recent L1 measurement prediction result and may be a real number.

$${Tn}^{′} = ( 1 - {a}^{′} ) \times Tn - {1}^{′} + {a}^{′} \times {Rn}^{′} , T {1}^{′} = R {1}^{′} \qquad [ Equation 27 ]$$

The terminal may indicate a trend in ranks of L1 measurement prediction results by reflecting filtered ranks of L1 measurement prediction results derived from the previous filtering window into the L1 filtering method that applies the weight to the rank of the recent L1 measurement prediction result, as shown in Equation 28. To this end, the base station may configure the terminal to reflect the filtered ranks of the L1 measurement prediction results of the previous filtering window. Equation 28 below may represent a method of L1 filtering that applies the weight to the rank of the recent L1 measurement prediction result and reflects the filtered ranks of L1 measurement prediction results of the previous filtering window. N L1 measurement prediction samples may exist within the filtering window. Rm′ may represent the rank of the M-th L1 measurement prediction result. Tn′ may represent the filtered rank of the N-th L1 measurement prediction result. T1′ may be set as shown in Equation 29. Here, T1′ may be set to R1′ according to Equation 29. a′ may represent the weight to be applied to the rank of the recent L1 measurement prediction result and may be a real number. Tn_pw′ may represent the filter rank of the N-th L1 measurement prediction result of the previous filtering window. b′ may represent the weight to be applied to the rank of the N-th L1 measurement prediction result of the previous filtering window. a′ may represent the weight to be applied to the rank of the recent L1 measurement prediction result.

$${Tn}^{′} = ( 1 - {a}^{′} ) \times Tn - {1}^{′} + {a}^{′} \times {Rn}^{′} \qquad [ Equation 28 ]$$

$$T {1}^{′} = {b}^{′} \times {Tn\_pw}^{′} + ( 1 - {b}^{′} ) \times R {1}^{′} \qquad [ Equation 29 ]$$

The terminal may apply L1 filtering starting from L1 measurement prediction performed after a time of configuring the filtering window. The base station may update the filtering window size while maintaining a balance between optimal beam allocation and handover frequency, and configure the updated filtering window size to the terminal. As another method, the base station may configure a starting time point of measurement prediction. A time duration corresponding to the filtering window size from the starting time point may be defined as a single filtering window.

As another method, the base station may configure the terminal with two or more filtering windows. In this case, a starting time point of measurement prediction for each filtering window may differ, or the sizes of the filtering windows may differ. For example, a first filtering window may be used for determining whether a handover is required, and a second filtering window may be used for determining whether the corresponding handover is an unnecessary handover. The L1 filtering method may be applied to identically to the L1 measurement result ranking method and L1 filtering method described above.

Meanwhile, the base station may configure the terminal to report the L1-filtered L1 measurement prediction result when a specific reporting condition is satisfied. Here, the specific reporting condition may correspond to the reporting condition shown in FIG. 8 or a specific event condition. The specific event condition may, for example, be as shown in Equation 30. In Equation 30, Ac′ may represent an L1-filtered L1 measurement prediction result for an SSB resource or CSI resource of a candidate cell. As' may represent an L1-filtered L1 measurement prediction result for an SSB resource or CSI resource of a serving cell. offset4 may an additional offset value configured to reduce frequent handovers. The base station may determine a value of offset4 and configure the value of offset4 to the terminal. The terminal may receive and recognize the value of offset4 from the base station. The terminal may report the L1 measurement prediction result to the base station if the specific event condition expressed in Equation 30 is satisfied. Additionally, the base station may configure the terminal with other event conditions.

$${Ac}^{′} \geq {As}^{′} + offset 4 \qquad [ Equation 30 ]$$

When the second filtering window is used for determining whether the handover is an unnecessary handover, the base station may configure the terminal to report the L1-filtered L1 measurement prediction result if a specific event condition is satisfied. As an example, the specific event condition may be configured as in Equation 31. Here, Ac′ may represent the L1-filtered L1 measurement prediction result for the SSB resource or CSI resource of the candidate cell, As′ may represent the L1-filtered L1 measurement prediction result for the SSB resource or CSI resource of the current serving cell, and offset5 may be an additional offset value configured to reduce frequent handovers. The base station may determine a value of offset5 and configure the value of offset5 to the terminal.

$${Ac}^{′} + offset 5 > {As}^{′} \qquad [ Equation 31 ]$$

offset5 may be equal to or different from offset4. Additionally, other event conditions may be configured. The base station may configure the terminal to report the L1 measurement prediction results to the base station when the L1 measurement prediction results from two filtering windows simultaneously satisfy a specific event condition. Alternatively, the base station may configure the terminal to report the L1 measurement prediction results when the L1 measurement prediction result from one filtering window satisfies the specific event condition.

Meanwhile, the base station may configure the terminal to report the L1-filtered rank of the L1 measurement prediction result when a specific reporting condition is satisfied. Here, the specific reporting condition may correspond to the reporting condition shown in FIG. 10. The specific reporting conditions may correspond to a specific event condition. As an example, the specific event condition may be as shown in Equation 32. In Equation 32, Tc′ may represent an L1-filtered rank of an L1 measurement prediction result for an SSB resource or CSI resource of a candidate cell. Ts' may represent an L1-filtered rank of the L1 measurement prediction result for an SSB resource or CSI resource of a current serving cell. offset6 may be an additional offset value configured to reduce frequent handovers. The base station may determine a value of offset6 and configure the value of offset6 to the terminal.

$${Tc}^{′} \geq {Ts}^{′} + offset 6 \qquad [ Equation 32 ]$$

When the second filtering window is used for determining whether the handover is an unnecessary handover, the base station may configure the terminal to report the L1-filtered L1 measurement prediction result if a specific event condition is satisfied. As an example, the specific event condition may be configured as in Equation 33 below. Here, Tc′ may represent the L1-fitered rank of the L1 measurement prediction result for the SSB resource or CSI resource of the candidate cell, Ts' may represent the L1-filtered L1 measurement prediction result for the SSB resource or CSI resource of the current serving cell, and offset7 may be an additional offset value configured to reduce frequent handovers. The base station may determine a value of offset7 and configure the value of offset7 to the terminal.

$${Tc}^{′} + offset 7 > {Ts}^{′} \qquad [ Equation 33 ]$$

Alternatively, the terminal may configure Tn′ such that Tn′ decreases as the L1 measurement prediction result is better. The specific event condition may be as shown in Equation 34. Here, Tc′ may represent the L1-filtered rank of the L1 measurement prediction result for the SSB or CSI resource of the candidate cell. Ts' may represent the L1-filtered rank of the L1 measurement prediction result for the SSB or CSI resource of the current serving cell. offset8 may be an additional offset value configured to reduce frequent handovers. The base station may determine a value of offset8 and configure the value of offset8 to the terminal. Additionally, the base station may configure other event conditions.

$${Tc}^{′} + offset 8 \leq {Ts}^{′} \qquad [ Equation 34 ]$$

When the second filtering window is used for determining whether the handover is an unnecessary handover, the base station may configure the terminal to report the L1-filtered L1 measurement prediction result when a specific event condition is satisfied. As an example, the specific event condition may be as shown in Equation 35. In this case, Tc′ may represent the L1-filtered rank of the L1 measurement prediction result for the SSB resource or CSI resource of the candidate cell. Ts' may represent the L1-filtered rank of the L1 measurement prediction result for the SSB resource or CSI resource of the current serving cell. offset9 may be an additional offset value configured to reduce frequent handovers. The base station may determine a value of offset9 and configure the value of offset9 to the terminal.

$${Tc}^{′} < {Ts}^{′} + offset 9 \qquad [ Equation 35 ]$$

offset9 may be equal to or different from offset8. Additionally, other event conditions may be configured. The base station may configure the terminal to report the ranks of the L1 measurement prediction results to the base station when the ranks of the L1 measurement prediction results from two filtering windows simultaneously satisfy a specific event condition. Alternatively, the base station may configure the terminal to report the ranks of the L1 measurement prediction results when the ranks of the L1 measurement prediction results from one filtering window satisfy the specific event condition.

Meanwhile, when reporting the ranks of L1 measurement prediction results, the terminal may also report the corresponding L1 measurement prediction results. As another method, the terminal may report only the L1 measurement prediction results based on the ranks of the L1 measurement prediction results. When reporting the corresponding L1 measurement prediction results, the terminal may report L1 measurement prediction results for L SSB/CSI resources in descending order of rank. The base station may determine a value of L and configure the value of L to the terminal. As another method, the terminal may use a predefined value of L. L may be a positive integer.

When reporting the ranks of L1 measurement prediction results, the terminal may report L1 measurement prediction results for M SSB/CSI resources to the terminal in descending order of rank. The base station may determine a value of M and configure the value of M to the terminal. As another method, the terminal may use a predefined value of M. M may be a positive integer.

Meanwhile, the base station can reduce the terminal's battery consumption by ensuring that measurement prediction is performed only when necessary. The base station may determine a specific event condition for the terminal to perform measurement prediction and configure the specific event condition to the terminal. The terminal may perform measurement prediction when the specific event condition is satisfied. As an example, the specific event condition may be configured as shown in Equation 36 below. In Equation 36, Ac may be an L1 measurement result of an SSB resource or CSI resource of a candidate cell or an L3 measurement result of the candidate cell. In Equation 36, As may be an L1 measurement result of an SSB resource or CSI resource allocated to a current serving cell or an L3 measurement result of the current serving cell. In Equation 36, offset10 may be an additional offset value configured to reduce frequent measurement predictions. The base station may determine a value of offset10 and configure the value of offset10 to the terminal. The measurement result may or may not apply filtering.

$$Ac + offset 10 \geq As \qquad [ Equation 36 ]$$

Additionally, the base station may configure other event conditions. As an example, the specific event condition may be configured as shown in Equation 37 below. In Equation 37, As may be the L1 measurement result of the SSB/CSI resource allocated to the current serving cell or the L3 measurement result of the serving cell. The base station may determine a threshold Th and configure the threshold Th to the terminal. The measurement results may or may not apply filtering.

$$As < T h \qquad [ Equation 37 ]$$

The above-described L1 measurement prediction result reporting method may be equally applied to a cell-level measurement prediction result reporting method. In this case, the cell-level measurement prediction result reporting method may differ from the L1 measurement prediction result reporting method in terms of the filtering scheme. In the cell-level measurement prediction result reporting method, L1 measurement to which L1 filtering is applied may be performed. Alternatively, in the cell-level measurement prediction result reporting method, L3 filtering may be applied to L1 measurement without L1 filtering. Alternatively, in the cell-level measurement prediction result reporting method, L3 filtering may be applied to measurement prediction results. In addition, the remaining operations in the cell-level measurement prediction result reporting method may be applied in the same manner as the L1 measurement prediction result reporting method.

The base station may configure the terminal performing L1 measurement prediction or cell-level measurement prediction to provide feedback on a prediction result accuracy. The base station may configure the terminal to periodically report the prediction result accuracy. Alternatively, the base station may configure the terminal to semi-persistently report the prediction result accuracy. Alternatively, the base station may configure the terminal to report the prediction result accuracy upon receiving a request from the base station. Alternatively, the base station may configure the terminal to report the prediction result accuracy when a specific event condition is satisfied.

The base station may configure a period or a time range within a single window period to calculate the prediction result accuracy. As an example, the specific event condition—may be configured as in Equations 38 to 43. In Equation 38, Accuracy may represent a prediction result accuracy. In Equation 39, Precision may represent a precision of the prediction result. In Equation 40, Recall may represent a recall rate. In Equation 41, Pfp may represent a false positive (FP) ratio. In Equation 42, Pfn may represent a false negative (FN) ration. In Equation 43, Pf may represent a false ratio. In Equations 38 to 43, TP may represent a true positive. In Equations 38, 41, 42, and 43, TN represents a true negative. Th1 to Th6 may represent thresholds. The base station may determine the thresholds and configure them to the terminal.

$$Accuracy = ( T P + TN ) / ( TP + F N + F P + T N ) < Th 1 \qquad [ Equation 38 ]$$

$$Precision = TP / ( TP + F P ) < Th 2 \qquad [ Equation 39 ]$$

$$Recall = TP / ( TP + F N ) < Th 3 \qquad [ Equation 40 ]$$

$$Pfp = FP / ( TP + F N + F P + T N ) \geq Th 4 \qquad [ Equation 41 ]$$

$$Pfn = FN / ( TP + F N + F P + T N ) \geq Th 5 \qquad [ Equation 42 ]$$

$$Pf = ( FN + FP ) / ( TP + F N + F P + T N ) \geq Th 6 \qquad [ Equation 43 ]$$

To this end, the terminal may maintain TP, TN, FP, and FN results for each prediction target. In machine learning classification problems, ensemble learning, which combines weaknesses of multiple models to improve overall classification performance, is known to be effective in enhancing classification accuracy. The ensemble learning may refer to a technique that combines prediction results of classifiers using two or more models to derive more accurate predictions. In the ensemble learning, weights may be assigned to the respective models, and the weights may be updated based on classification results to improve prediction accuracy.

The base station may appropriately adjust the weights applied to the respective models based on prediction accuracy feedback received from the terminal to enhance classification performance. As another method, the base station may determine and configure for the terminal weight update step sizes for the respective models, along with the aforementioned ratios and thresholds. Alternatively, the terminal may determine and configure the weight update step size, ratios, and thresholds for the respective models. For example, if Pfp≥Th7, the terminal may increase a weight applied to a first model by 0.1 and decrease a weight applied to a second model by 0.1. Here, the first model may predominantly cause false negatives (FNs) among False classifications, while the second model may predominantly cause false positives (FPs) among

False classifications.

As another example of specific event conditions, the following may be configured. The base station may determine and configure for the terminal the threshold values such as K, Th8, etc.:
Top-1 accuracy: A ratio at which an SSB/CSI resource or cell predicted as Top-1 matches an actual Top-1<Th8
Top-K/1 accuracy: A ratio at which an SSB/CSI resource or cell predicted as Top-K matches an actual Top-1<Th9
Top-1/K accuracy: A ratio at which an SSB/CSI resource or cell predicted as Top-1 matches an actual Top-K<Th10

The base station may configure the terminal performing L1 measurement prediction or cell-level measurement prediction to provide feedback on the prediction results and actual measurement results. When the actual measurement results become available, the terminal may provide feedback on both the prediction results and the actual measurement results. If the serving cell changes due to a handover, a target cell to which the terminal newly connects may transmit the feedback results received from the terminal to the previous serving cell to update the machine learning model's performance.

Meanwhile, the base station may configure the terminal performing L1 measurement prediction or cell-level measurement prediction to provide feedback when an event that is not triggered by a prediction result occurs according to conventional scheme. If a measurement report trigger event not derived from the prediction result occurs, the base station may configure the terminal to provide feedback thereon. Based on the configuration, the terminal may provide feedback on both the prediction results and the actual measurement results.

The terminal may transmit the feedback to the serving cell it is currently connected to. Alternatively, the terminal may transmit the feedback to the newly connected target cell after a handover. The target cell may receive the feedback from the terminal and forward the received feedback to the previous serving cell. If a radio link failure (RLF) event not derived from the prediction result occurs, the base station may configure the terminal to provide feedback on the RLF. Based on the configuration, the terminal may provide feedback on the prediction result and the actual measurement result. The terminal may transmit the feedback after completing an RLF recovery procedure, and the target cell receiving the feedback may forward the received feedback to the previous serving cell.

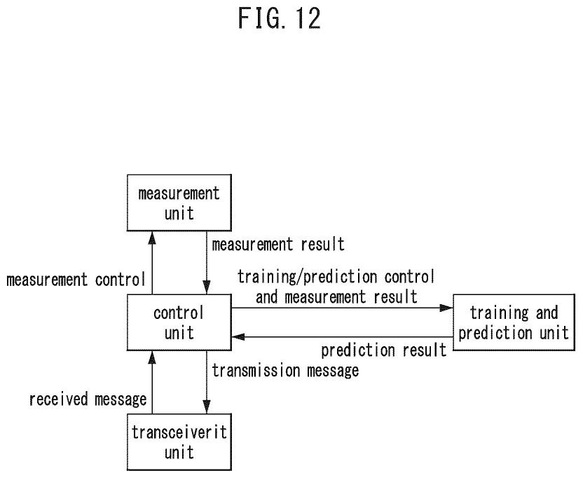

FIG. 12 is a block diagram illustrating exemplary embodiments of a terminal supporting measurement reporting methods in a mobile communication system.

Referring to FIG. 12, a transceiver unit may deliver a message received from the base station to a control unit. The control unit may provide measurement control-related information to a measurement unit according to configuration information of the received message. Then, the control unit may provide training and prediction control-related information to a training and prediction unit according to the configuration information of the received message. The measurement unit may measure signal strengths for the serving cell and candidate cells based on the measurement control-related configuration information and deliver the measurement results to the control unit.

When necessary, the control unit may forward the measurement results received from the measurement unit to the training and prediction unit. The training and prediction unit may perform training and prediction using the measurement results received from the control unit based on training and prediction-related control configuration information. When necessary, the training and prediction unit may deliver the prediction results to the control unit. Based on the measurement results received from the measurement unit and the prediction results received from the training and prediction unit, the control unit may construct a transmission message if there is information to report to the base station, and deliver the transmission message to the transceiver unit, thereby allowing the transmission message to be transmitted.

According to the methods in the present disclosure, the terminal can frequently report beam measurement results in a situation where the optimal beam changes frequently, and the terminal can occasionally report beam measurement results in a situation where the optimal beam changes infrequently. As a result, the terminal can increase the likelihood of assigning the optimal beam while reducing signaling overhead.

Additionally, the base station may utilize the measurement prediction results to determine whether a handover event is unnecessary when the handover event occurs. If the handover is determined to be an unnecessary handover, the base station may prevent the handover from being triggered. Accordingly, the base station can reduce the frequency of handovers, thereby decreasing interruption time, and execute a handover to a better cell more quickly, enhancing the user's perceived transmission speed. Moreover, the base station can improve the performance of the measurement prediction model through prediction results and feedback on conventional event occurrences.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal, comprising:
receiving, from a base station, configuration information on first reference signal resources;
obtaining a measurement result by performing measurement on the first reference signal resources according to the configuration information;
performing layer 1 (L1) filtering on the measurement result; and
in response to the L1-filtered measurement result satisfying a measurement reporting condition, reporting the L1-filtered measurement result to the base station.

2. The method according to claim 1, wherein the performing of the L1 filtering on the measurement result comprises:
identifying a filtering window;
in response to the filtering window being a new filtering window, performing initialization of the L1 filtering; and
performing the L1 filtering based on the filtering window.

3. The method according to claim 2, wherein the performing of the L1 filtering based on the filtering window comprises:
identifying L1 measurement samples within the filtering window; and
performing the L1 filtering based on the L1 measurement samples.

4. The method according to claim 3, wherein the performing of the L1 filtering based on the L1 measurement samples comprises:
applying weights to the L1 measurement samples; and
performing the L1 filtering based on the L1 measurement samples to which the weights are applied.

5. The method according to claim 2, wherein the performing of the L1 filtering based on the filtering window comprises:
identifying an L1-filtered measurement result of a previous filtering window of the filtering window;
identifying L1 measurement samples within the filtering window; and
performing the L1 filtering based on the L1 measurement samples within the filtering window and the L1-filtered measurement result of the previous filtering window.

6. The method according to claim 1, further comprising:
receiving, from the base station, prediction configuration information on second reference signal resources;
obtaining a measurement prediction result by performing measurement prediction on the second reference signal resources according to the prediction configuration information;
performing L1 filtering on the measurement prediction result; and
in response to the L1-fitered measurement prediction result satisfying a measurement prediction reporting condition, reporting the L1-filtered measurement prediction result to the base station.

7. The method according to claim 6, wherein the prediction configuration information further includes a measurement prediction condition, and the performing of the measurement prediction on the second reference signal resources comprises: in response to the measurement prediction condition being satisfied, performing measurement prediction on the second reference signal resources according to the prediction configuration information.

8. The method according to claim 7, wherein the measurement prediction condition is satisfied when a value obtained by adding a first offset to an L1-filterd L1 measurement result of a reference signal resource of a candidate cell is greater than or equal to an L1-filtered L1 measurement result of a reference signal resource of a serving cell.

9. The method according to claim 7, wherein the measurement prediction condition is satisfied when an L1-filtered L1 measurement result of a reference signal resource of a serving cell is less than a threshold.

10. The method according to claim 7, further comprising:
receiving, from the base station, a feedback request for a prediction result accuracy;
calculating the prediction result accuracy according to the feedback request; and
transmitting the calculated prediction result accuracy to the base station.

11. The method according to claim 10, wherein the prediction result accuracy includes at least one of accuracy, precision, recall rate, false positive ratio, false negative ratio, or false ratio for the measurement prediction result.

12. The method according to claim 1, wherein the measurement reporting condition is satisfied when an L1-filtered L1 measurement result of a reference signal resource of a candidate cell is equal to or greater than an L1-filtered L1 measurement result of a reference signal resource of a serving cell, by a second offset.

13. A method of a base station, comprising:
transmitting, to a terminal, configuration information on first reference signal resources and a measurement reporting condition; and
receiving, from the terminal, a layer 1 (L1)-filtered measurement result for the first reference signal resources according to the configuration information,
wherein the L1-filtered measurement result satisfies the measurement reporting condition.

14. The method according to claim 13, wherein the measurement reporting condition is satisfied when an L1-filtered L1 measurement result of a reference signal resource of a candidate cell is equal to or greater than an L1-filtered L1 measurement result of a reference signal resource of a serving cell, by a second offset.

15. The method according to claim 13, further comprising:
transmitting, to the terminal, prediction configuration information for second reference signal resources and a prediction reporting condition; and
receiving, from the terminal, an L1-filtered measurement prediction result for the second reference signal resources according to the prediction configuration information.

16. The method according to claim 15, further comprising:
requesting, from the terminal, a feedback for a prediction result accuracy; and
receiving, from the terminal, the prediction result accuracy according to the feedback request.

17. A terminal comprising at least one processor, wherein the at least one processor causes the terminal to perform:
receiving, from a base station, configuration information on first reference signal resources;
obtaining a measurement result by performing measurement on the first reference signal resources according to the configuration information;
performing layer 1 (L1) filtering on the measurement result; and
in response to the L1-filtered measurement result satisfying a measurement reporting condition, reporting the L1-filtered measurement result to the base station.

18. The terminal according to claim 17, wherein in the performing of the L1 filtering on the measurement result, the at least one processor causes the terminal to perform:
identifying a filtering window;
in response to the filtering window being a new filtering window, performing initialization of the L1 filtering; and
performing the L1 filtering based on the filtering window.

19. The terminal according to claim 17, wherein the at least one processor further causes the terminal to perform:
receiving, from the base station, prediction configuration information on second reference signal resources;
obtaining a measurement prediction result by performing measurement prediction on the second reference signal resources according to the prediction configuration information;
performing L1 filtering on the measurement prediction result; and
in response to the L1-fitered measurement prediction result satisfying a measurement prediction reporting condition, reporting the L1-filtered measurement prediction result to the base station.

20. The terminal according to claim 19, wherein the at least one processor further causes the terminal to perform:
receiving, from the base station, a feedback request for a prediction result accuracy;
calculating the prediction result accuracy according to the feedback request; and
transmitting the calculated prediction result accuracy to the base station.
